(19) United States
(12) Patent Application Publication
(10) Pub. No.: US 2008/0178267 A1
(43) Pub. Date: Jul. 24, 2008

(54) METHOD AND SYSTEM FOR SIMPLIFYING ROLE BASED AUTHORIZATION PROFILE IMPLEMENTATION

(76) Inventors: Murali Rajagopal, Irvine, CA (US); Hemal Shah, Trabuco Canyon, CA (US)

Correspondence Address: MCANDREWS HELD & MALLOY, LTD, 500 WEST MADISON STREET, SUITE 3400, CHICAGO, IL, 60661, US

(21) Appl. No.: 12/014,201

(22) Filed: Jan. 15, 2008

Related U.S. Application Data
(60) Provisional application No. 60/885,521, filed on Jan. 18, 2007.

(51) Int. Cl. G06F 21/00

(52) U.S. Cl. 726/4

(57) ABSTRACT

A two-level authorization of role and/or account based requested service operation may be performed in a system managed via Distributed DMTF, based on the CIM data model. The first level of authorization may be based on service-level availability of requested service operation based on determination of all available service operations in the managed system. Within the RBA profile, the CIM_RoleBasedAuthorizationService class and/or the CIM_RoleBasedManagementCapabilities class may enable performing service-level authorization. Similarly, within the SIM profile, the CIM_AccountManagementService class and/or the CIM_AccountManagementCapabilities class may enable performing service-level authorization. The second level authorization may be based on instance-level availability of requested service operation based on determination of available service operations via specific role and/or account instances wherein the CIM_EnabledLogicalElementCapabilities class may enable authorizing available service operations via instances of CIM_Role and/or CIM_Account classes. Instances of CIM_Role and/or CIM_Account classes may also advertise instance-specific service operations via associated instances of CIM_EnabledLogicalElementCapabilities class.

### CROSS-REFERENCE TO RELATED APPLICATIONS/INCORPORATION BY REFERENCE

This patent application makes reference to, claims priority to and claims benefit from U.S. Provisional Application Ser. No. 60/885521 filed on Jan. 18, 2007.

The above stated application is hereby incorporated herein by reference in its entirety.

### FEDERALLY SPONSORED RESEARCH OR DEVELOPMENT

[Not applicable].

### MICROFICHE/COPYRIGHT REFERENCE

[Not applicable].

### FIELD OF THE INVENTION

Certain embodiments of the invention relate to network management. More specifically, certain embodiments of the invention relate to a method and system for simplifying role based authorization profile implementation.

### BACKGROUND OF THE INVENTION

Information Technology (IT) management may require performing remote management operations of remote systems to perform inventory and/or to determine whether remote systems are up-to-date. For example, management devices and/or consoles may perform such operations as discovering and/or navigating management resources in a network, manipulating and/or administrating management resources, requesting and/or controlling subscribing and/or unsubscribing operations, and executing and/or specific management methods and/or procedures. Management devices and/or consoles may communicate with devices in a network to ensure availability of remote systems, to validate that systems may be up-to-date, and/or to perform any security patch updates that may be necessary.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for simplifying role based authorization profile implementation, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram that illustrates an exemplary communication setup between a management device and a network device, which may be utilized in accordance with an embodiment of the invention.

FIG. 2A is a block diagram that illustrates an exemplary Role Based Authorization class profile, which may be utilized in accordance with an embodiment of the invention.

FIG. 2B is a block diagram that illustrates an exemplary Simple Identity Management class profile, which may be utilized in accordance with an embodiment of the invention.

FIG. 3 is a block diagram that illustrates a modified CIM_Role implementation that enables instance-specific capabilities authorization, in accordance with an embodiment of the invention.

FIG. 4 is a flow chart that illustrates two-level authorization of role and/or account based services in a network device, in accordance with an embodiment of the invention.

### DETAILED DESCRIPTION OF THE INVENTION

Certain embodiments of the invention may be found in a method and system for simplifying role based authorization profile implementation. Various embodiments of the invention may comprise performing a two-level authorization of role and/or account based requested service operation. The system may be managed via Distributed Management Task Force (DMTF) management profiles, based on the Common Information Model (CIM) protocol. The first level of authorization may be based on service-level availability of requested service operation based on determination of available service operations in the managed system. Within the DMTF Role Based Authorization (RBA) profile, a single instance of the CIM_RoleBasedAuthorizationService class and/or single instance of the CIM_RoleBasedManagementCapabilities class may enable performing service-level authorization. Similarly, within the DMTF Simple Identity Management (SIM) profile, a single instance of the CIM_AccountManagementService class and/or single instance of the CIM_AccountManagementCapabilities class may enable performing service-level authorization. A second level authorization may be based on instance-level availability of requested service operation based on determination of available service operations via a specific role and/or account instance. Within the RBA profile, a single instance of the CIM_EnabledLogicalElementCapabilities class associated with a single instance of the CIM_Role class may enable performing instance-level authorization. Similarly, within the SIM profile, a single instance of the CIM_EnabledLogicalElementCapabilities class associated with a single instance of the CIM_Account class may enable performing instance-level authorization. Instances of CIM_Role and/or CIM_Account classes may also advertise instance-specific service operations via associated instances of the CIM_EnabledLogicalElementCapabilities class.

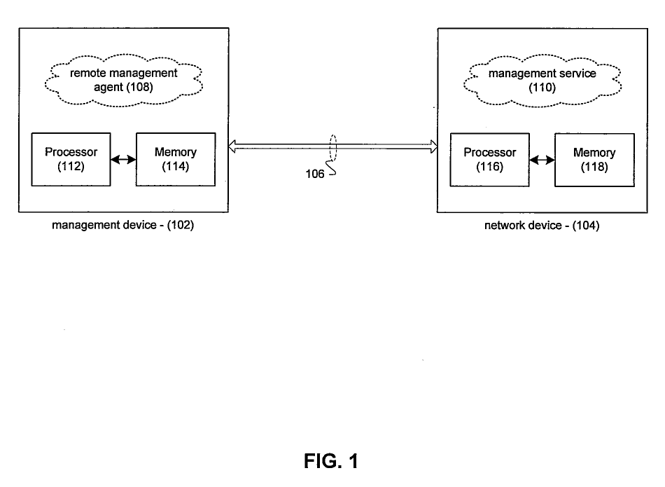

FIG. 1 is a block diagram that illustrates an exemplary communication setup between a management device and a network device, which may be utilized in accordance with an embodiment of the invention. Referring to FIG. 1, there is shown a management device 102, a network device 104, a management connection 106, a remote management agent 108, a management service 110, a processor 112, a memory 114, a processor 116, and a memory 118.

The management device 102 may comprise suitable logic, circuitry, and/or code that may enable management of network devices, for example the network device 104, via a management connection, for example the management connection 106. For example, the management device 102 may be utilized by Information Technology (IT) operators to enable management of various devices in an IT network. The management device 102 may also comprise a dedicated entity, for example, the remote management agent 108, to enable performing management operations, which may comprise discovering and/or navigating management resources in a network, manipulating and/or administrating management resources, requesting and/or controlling subscribing and/or unsubscribing operations, and executing and/or specific management methods and/or procedures. The management device 102 may perform management operations, via the remote management agent 108 for example, wherein the management device 102 may communicate with devices in a network to ensure availability of remote systems, to validate that systems may be up-to-date, and/or to perform any security patch updates that may be necessary.

The processor 112 may comprise suitable logic, circuitry and/or code that may enable performing processing operations, for example management related operations, in the management device 102. The invention may not be limited to a specific processor, but may comprise for example, a general purpose processor, a specialized processor or any combination of suitable hardware, firmware, software and/or code, which may be enabled to provide two-level authorization in accordance with the various embodiments of the invention.

The memory 114 may comprise suitable logic, circuitry and/or code that may enable permanent and/or non-permanent storage and fetch of data and/or code used by the processor 112, for example during management related processing operations.

The remote management agent 108 may comprise suitable logic, circuitry, and/or code that may enable performing management operations based on one or more management standards. For example, the remote management agent 108 may enable performing control and/or management operations, based on Web Service Management (WS-Management) and/or Alert Standard Format (ASF) protocols, of existing and/or known nodes, which support similar protocols, in a network. The remote management agent 108 may comprise a logical and/or software entity that may be integrated within an OS running in the management device 102. The remote management agent 108 may also comprise a logical and/or software entity that may be integrated within a general network controller (NIC) which may be running in the management device 102. The remote management agent 108 may comprise a logical and/or software entity that may be integrated within a dedicated management sub-system within the management device 102, comprising, for example, the processor 112 and/or the memory 114.

The network device 104 may comprise suitable logic, circuitry, and/or code that may enable management by one or more management devices, for example the management device 102, via a management connection, for example the management connection 106. The network device 104 may be integrated into a network that may be managed by the management device 102. For example, the network device 104 may comprise a personal computer (PC), which may be operated in a network managed by the management device 102. The network device 104 may also comprise a dedicated entity, for example the management service 110, to enable participating in management operations.

The processor 116 may comprise suitable logic, circuitry and/or code that may enable performing processing operations, for example management related operations, in the network device 104. The invention may not be limited to a specific processor, but may comprise for example, a general purpose processor, a specialized processor or any combination of suitable hardware, firmware, software and/or code, which may be enabled to provide two-level authorization in accordance with the various embodiments of the invention.

The memory 118 may comprise suitable logic, circuitry and/or code that may enable permanent and/or non-permanent storage and fetch of data and/or code used by the processor 116, for example during management related processing operations.

The management service 110 may comprise logic, circuitry, and/or code that may enable performing management operation based on one or more management standards. For example, the management service 110 may enable participating in control and/or management operations, based on WS-Management and/or ASF protocols. The management service 110 may comprise a logical and/or software entity that may be integrated within an OS running in the network device 104. The management service 110 may also comprise a logical and/or software entity that may be integrated within a general network controller (NIC) which may be running in the network device 104. Additionally, the management service 110 may comprise a logical and/or software entity that may be integrated within a dedicated management sub-system within the network device 104, comprising, for example, the processor 116 and/or the memory 118.

The management connection 106 may comprise interface and/or link that may enable interactions between devices in a managed network. For example, the management connection 106 may enable management communication between the management device 102 and network devices such as the network device 104. The management connection 106 may utilize one or more standards-based management protocols. For example, the management connection 106 may comprise use of one or more management protocols specified and/or published by standards entities such as the Distributed Management Task Force (DMTF). The management connection 106 may comprise utilizing DMTF-based Alert Standard Format (ASF) protocol messaging and/or WS-Management (WS-Man) protocol messaging.

The Alert Standard Format (ASF) protocol may be utilized in first generation out-of-band management systems. The ASF protocol may comprise utilization of User Datagram Protocol (UDP) stack to enable communication between management devices and network devices. Devices comprising ASF functionality and/or interface may be ASF capable, wherein said devices may perform management operations via ASF messages. For example, in instances where the network device 104 may be ASF capable, the management device 102 may utilize ASF based messaging to perform management of the network device 104. More recently, WS-Management (WS-MAN) was proposed and developed as the next generation management protocol. The WS-Management is a specification based on Web Services, which typically utilize SOAP (XML based messaging) and HTTP(S) as a SOAP transport for communications. SOAP over HTTP(S) may require HTTP/TLS/TCP stack implementation, which may ensure improved security, reliability, and OS-independence.

The DASH, a DMTF management standard work group, has defined a Common Information Model (CIM) based instrumentation, analogous to object oriented representation of management data, of a managed subsystem that may be accessed using the WS-Management protocol. The CIM may provide common definition of management information for systems, networks, applications and services, and allows for vendor extensions. Devices that may comprise Intelligent Platform Management Interface (IPMI) or ASF internal interfaces and/or protocols may be may be managed externally via WS-Management messages. For example, in instances where the network device 104 may comprise IPMI or ASF based internal communications within the components of the network device 104, the management device 102 may utilize WS-Management based messaging to perform management of the network device 104 based on CIM-based mechanisms. Additionally, within the DMTF framework, the Web-Based Enterprise Management (WBEM) is defined as a platform and resource independent DMTF standard that defines both a common model (i.e., description) and protocol (i.e., interface) for monitoring and controlling resources from diverse sources (e.g. different types of platforms or different types of resources on the same platform). WBEM is defined by a set of standards that include: a data description, an encoding, and a transport protocol. The WBEM may utilize CIM-based models for the description of management data that is not bound to any particular implementation.

In operation, the network device 104 may be managed via the management device 102. For example, the management device 102 may utilize the management connection 106 to perform management operations in the network device 104. The management connection 106 may utilize one or more standards-based management protocols to enable performing management operations between the management device 102 and the network device 104. For example, the remote management agent 108 and/or the management service 110 may enable utilizing WS-management messaging, via the management connection 106, to enable management operations between the management device 102 and the network device 104.

The WBEM/CIM may allow remote management, control, and/or access of subsystems, components, and/or devices within a managed system. For example, the network device 104 may comprise and/or constitute a WBEM/CIM server within the WBEM framework to enable remote interactions and/or access via WBEM/CIM clients, which may be run within management consoles, for example the management device 102. Additionally, CIM-based providers may be utilized within a managed system, for example the network device 104, to enable direct interactions and/or communications with specific components, subsystems, and/or devices within the network device 104.

Because of the potential security risks and/or breaches posed when remote access and/or management is utilized, the DMTF standards provide, within the CIM infrastructure, management profiles and/or mechanisms to enable regulating and controlling management access in managed systems. For example, access to managed systems, for example the network device 104, by management devices, for example the management device 102, to perform management operations may be subject to ‘security principals’ within the DMTF/CIM management terminology. The security principal may exist on a managed system, for example the network device 104, and it may be utilized to provide the security context under which the authenticated user and group may act within a managed system; and DMTF management profiles to enable use of security principals. Various parameters and/or attributes may be defined in these management profiles, and may be utilized in conjunction with security principals. For example, The Simple Identity Management (SIM) profile may provide the ability to manage and/or control accessibility to network devices in the form of local accounts. A SIM implementation, in the network device 104 for example, may enable authorization of account information and/or capabilities that a security principal may utilize while attempting to access the network device 104, via the management device 102 for example, in order to perform management operations. Consequently, the SIM implementation may provide one or more of available account-related services and/or operations that may comprise creating, modifying, and/or deletion of accounts.

Other management profiles may also be utilized to improve security in managed network devices. For example, the Role Based Authorization (RBA) Profile may provide the ability to authenticate role properties of security principals accessing managed systems. Within the meaning of DMTF/CIM, a security principal may have one or more known and/or fixed roles that may comprise an administrator role, and operator role, and/or a read-only role. An RBA implementation, in the network device 104 for example, may enable authorization of role information and/or capabilities that a security principal may utilize while attempting to access the network device 104, via the management device 102 for example, in order to perform management operations. Consequently, the RBA implementation may provide one or more of available role-related services and/or operations that may comprise creating, modifying, showing, and/or deletion of roles.

The SIM and/or RBA profiles may be utilized within WBEM/CIM to enable secure management operations. The SIM profile and/or the RBA profile may be implemented in the management device 102, within CIM-based providers for instance, via the remote management agent 108, the processor 112, and/or the memory 114, for example. Similarly, the SIM profile and/or the RBA profile may be implemented in the network device 104, within CIM-based providers for instance, via the management service 110, the processor 116, and/or the memory 118, for example.

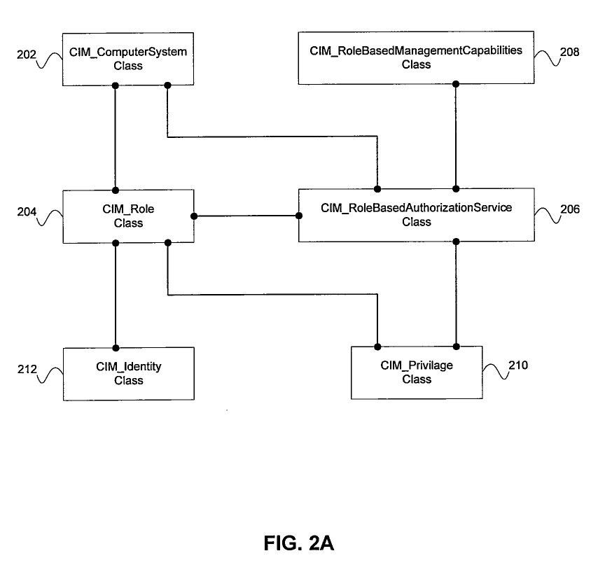

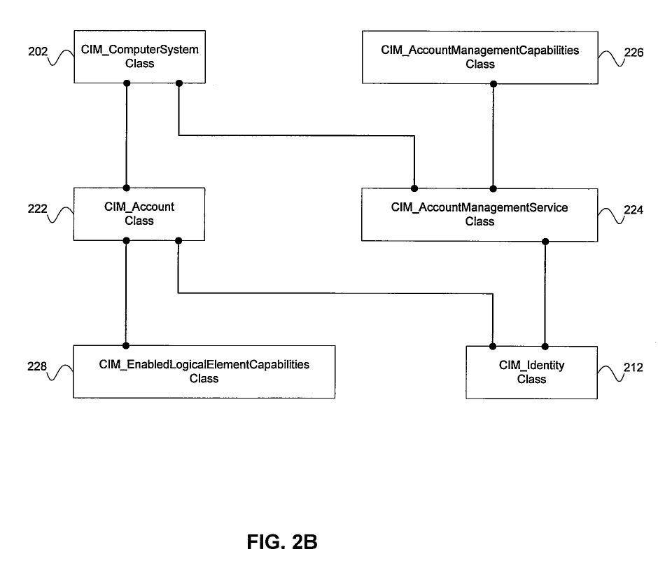

FIG. 2A is a block diagram that illustrates an exemplary Role Based Authorization class profile, which may be utilized in accordance with an embodiment of the invention.

Referring to FIG. 2A, there is shown a CIM_ComputerSystem class 202, a CIM_Role class 204, a CIM_RoleBasedAuthorizationService class 206, a CIM_RoleBasedManagementCapabilities class 208, a CIM_Privilege class 210, and a CIM_Identity class 212.

The CIM_ComputerSystem class 202 may comprise functionality that may represent the managed system within Role Based Authorization (RBA) profile. For example, an instance of the CIM_ComputerSystem class 202 may represent the network device 104 in a RBA profile.

The CIM_Role class 204 may comprise functionality that may represent a role that may be available within a RBA profile. The authorized roles on a managed system may be represented through instances of the CIM_Role class 204.

The CIM_RoleBasedAuthorizationService class 206 may comprise a central functionality in RBA, wherein role related and/or based services that may be requested via an instance of the CIM_ComputerSystem class 202 may be handled via an instance of the CIM_RoleBasedAuthorizationService class 206. Consequently, the ability to manage and configure roles for a managed system may be represented by a CIM_RoleBasedAuthorizationService instance. The CIM_RoleBasedAuthorizationService class 206 is the central class of RBA profile and, through extrinsic methods, serves as the interface for a client to request deletion and modification of existing roles, creation of new roles, and assignment of roles to security principals.

The CIM_RoleBasedManagementCapabilities class 208 may comprise functionality that may represent available role services and/or capabilities in a managed system. For example, the CIM_RoleBasedManagementCapabilities 208 may comprise a SupportedMethods property member, which may represent values indicating role services and/or capabilities that may be available in a system represented by an instance of the CIM_ComputerSystem 202.

The CIM_Privilege class 210 may comprise functionality that represents one or more rights and/or privileges associated with a role. Rights and/or privileges that may be granted to a security principal through membership in a role may be represented by instances of CIM_Privilege that are associated with the instance of CIM-Role, for example the CIM_Role class 202.

The CIM_Identity class 212 may comprise functionality that may enable representing security principals accessing a managed system. The instantiation of the CIM_Identity class 212 instance, which represents a security principal, may correspond to an authenticated user within the meaning of the Simple Identity Management (SIM) profile, and CIM_Identity class 212 instances that may represent security principals for accounts, may have a direct association to appropriate CIM_Role class 204 class instances.

In operation, the RBA may enable authenticating and/or authorizing role related operations in a managed system. During management operations, a role related operation may be requested in a managed system, for example the network device 104, which may represented in the RBA profile via an instance of the CIM_ComputerSystem class 202. Authorized roles on a managed system, for example the network device 104, may be represented through instances of the CIM_Role class 204. Rights granted to a security principal, which may be represented via the CIM_Identity class 212, through membership in a role may be represented by instances of the CIM_Privilege class 210 that may be associated with the instance of the CIM_Role class 204. When a security principal is a member of an authorized role, the security principal may be granted the cumulative privileges of the role. Every authorized role on the network device 104 may have a set of explicitly granted or denied privileges based on one or more instances of the CIM_Privilege class 210. Each instance of the CIM_Privilege class 210 may define granted privilege, and/or activities permissible within each granted privilege.

The RBA profile may enable one or more role related operations in a managed system. Role related operations may comprise CreateRole, ShowAccess, ShowRoles, AssignRoles, ModifyRoles, and/or DeleteRole. The CIM_RoleBasedAuthorizationService class 206 may enable configuration and/or management of available roles within the network device 104. The operational method of an instance of role may be realized by specifying the required properties in the CIM_RoleBasedAuthorizationService class 206 as well as in the SupportedMethods property of the CIM_RoleBasedManagementCapabilities class 208. The Role based authorization may necessitate determining support of necessary operational methods via the CIM_RoleBasedAuthorizationService class 206 and an associated CIM_RoleBasedManagementCapabilities class 208. For example, to perform a ‘CreateRole’ in the network device 104, a CreateRole( ) operational method may be supported in an instance of CIM_RoleBasedAuthorizationService class 206 associated with an instance of the CIM_ComputerSystem class 202 representing the network device 104, and SupportedMethods property of an instance of the CIM_RoleBasedManagementCapabilities class 208 may indicate support of CreateRole as well.

Within the current RBA profile, the use of the CIM_RoleBasedAuthorizationService class 206 and associated CIM_RoleBasedManagementCapabilities class 208 may be utilized to invoke potentially available role operations in a managed system. However, while the current implementation may work where the roles in a managed system share identical authorizations. In instances where different roles are used in a managed system with different authorizations, the standard approach may not be sufficient since a single instance of CIM_RoleBasedAuthorizationService class 206 and/or single instance of the CIM_RoleBasedManagementCapabilities class 208 may be insufficient and/or incapable of representing varying support requirement of the different roles. Consequently, multiple instances of the CIM_RoleBasedAuthorizationService class 206 and/or the CIM_RoleBasedManagementCapabilities class 208 may be necessary to enable authorization of various roles that may support different operational methods. Such approach may not be desirable, especially in systems with processing and/or memory limitations.

FIG. 2B is a block diagram that illustrates an exemplary Simple Identity Management class profile, which may be utilized in accordance with an embodiment of the invention. Referring to FIG. 2B, there is shown the CIM_ComputerSystem class 202, the CIM_Identity class 212, a CIM_Account class 222, a CIM_AccountManagementService class 224, a CIM_AccountManagementCapabilities class 226, and a CIM_EnabledLogicalElementCapabilities class 228.

The CIM_ComputerSystem class 202 may be comprised substantially as described in FIG. 2A; however, here an instance of the CIM_ComputerSystem class 202 may represent the network device 104 within a Simple Identity Management (SIM) profile.

The CIM_Identity class 212 may be comprised substantially as described in FIG. 2A; however, an instance of the CIM_Identity class 212 within the SIM profile may represent security principal for accounts that may exist in the network device 104, and which may be defined based on the CIM_Account class 222. Within SIM profile, the CIM_Identity class 212 may represent a security principal, and an instance of the CIM_Identity class 212 may be used to associate the security principal with the entity whose privileges are being managed. Local accounts may have one or more associated security principals.

The CIM_Account class 222 may comprise functionality that may represent accounts defined locally on a managed system. For example, an instance of the CIM_Account class 222 may represent an account that may be utilized to access and/or managed the network device 104. The CIM_EnabledLogicalElementCapabilities class 228 may comprise functionality that may enable storing and/or updating identification information pertaining to an instance of the CIM_Account class 222. An instance of the CIM_EnabledLogicalElementCapabilities class 228 may be used to indicate additional account policies supported for a specific account. The parameters for the policy are provided by properties of an instance of the CIM_Account class.

The CIM_AccountManagementService class 224 may comprise functionality that may enable managing accounts on a managed system within SIM profile. The CIM_AccountManagementCapabilities class 226 may comprise functionality that may represent relevant information pertaining to available account services and/or capabilities in a managed system. An instance of the CIM_AccountManagementCapabilities class 226 may be utilized in managing of a service, represented via an instance of the CIM_AccountMangementService class, and/or in managing accounts utilized via the CIM_AccountMangementService instance.

In operation, the Simple Identity Management (SIM) profile may provide the ability to perform management of user accounts of a managed system, for example the network device 104, which may be represented via an instance of the CIM_ComputerSystem 202, and which may use basic user ID and password authentication for enabling and/or authenticating management access. The SIM profile may also provide the ability to represent a security principal that has been authenticated through third-party authentication.

During management operations, an account related operation may be requested in a managed system, for example the network device 104, which may represented in SIM profile via an instance of the CIM_ComputerSystem class 202. Authorized accounts on a managed system, for example the network device 104, may be represented through instances of the CIM_Account class 222. Each instance of CIM_Account 222 may correspond to a security principal, which may be represented via instances of the CIM_Identity class 212.

The SIM profile may enable one or more account related operations in a managed system. Account related operations may comprise Create, Modify, and/or Delete. The CIM_AccountManagementService class 224 may enable configuration and/or management of available accounts within the network device 104. The operational method of an instance of a role may be realized by specifying the required properties in the CIM_AccountManagementService class 224 as well as in the SupportedMethods property of the CIM_AccountManagementCapabilities class 226. Account authorization may necessitate determining support of necessary operational methods via the CIM_AccountManagementService class 224 and an associated CIM_AccountManagementCapabilities class 226. For example, to perform an account ‘Modify’ in the network device 104, a Modify operational method need be supported via an instance of CIM_AccountManagementService class 224 associated with an instance of the CIM_ComputerSystem class 202 representing the network device 104, and SupportedMethods property of an instance of the CIM_AccountManagementCapabilities class 226 need indicate support of ‘Modify’ as well. Within the current SIM profile, use of the CIM_AccountManagementService class 224 and associated CIM_AccountManagementCapabilities class 226 may be utilized to invoke all potentially available account operations in a managed system. However, while the current implementation may work where all accounts in a managed system may share identical authorizations, if different accounts were used in a managed system with different authorizations, the current approach may not be sufficient since a single instance of CIM_AccountManagementService class 224 and/or single instance of the CIM_AccountManagementCapabilities class 226 may be insufficient and/or incapable of representing varying supported operations of the different accounts. Consequently, multiple instances of the CIM_AccountManagementService class 224 and/or the CIM_AccountManagementCapabilities class 226 may be necessary to enable authorization of various roles that may support different operational methods. Such approach may not be desirable, especially in systems with processing and/or memory limitations.

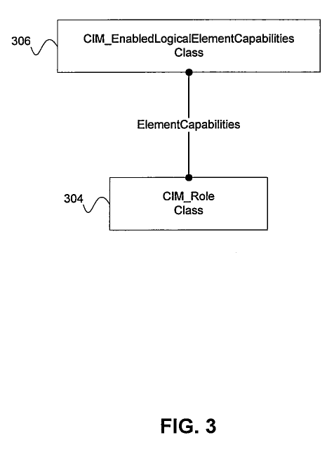

FIG. 3 is a block diagram that illustrates a modified CIM_Role implementation that enables instance-specific capabilities authorization, in accordance with an embodiment of the invention. Referring to FIG. 3, there is shown a CIM_Role class 304 and a CIM_EnabledLogicalElementCapabilities class 306.

The CIM_Role class 304 may be substantially similar to the CIM_Role class 204. However, the CIM_Role class 304 may enable association with an instance of the CIM_EnabledLogicalElementCapabilities class 306 to facilitated role specific authorization.

The CIM_EnabledLogicalElementCapabilities 306 may be substantially similar to the CIM_EnabledLogicalElementCapabilities class 228. However, the CIM_EnabledLogicalElementCapabilities 306 may comprise a SupportedMethods property that may enable performing role-specific, or account-specific, authorization of requested operation.

In operation, the CIM_EnabledLogicalElementCapabilities 306 may enable determining availability of requested operations for an associated role.

The CIM_EnabledLogicalElementCapabilities 306 may enable instance-specific authorization of requested role based service requests. An instance of the CIM_EnabledLogicalElementCapabilities 306 may be instantiated and associated with each instance of the CIM_Role class 304, within RBA profile, as substantially described in FIG. 2A. During role based authorization, a two-level validation may be utilized in the network device 104. First, service-level authorization may be performed, wherein the SupportedMethods property of an instance of the CIM_RoleBasedManagementCapabilities class 208 may be utilized to determine availability of the requested operation via an associated instance of the CIM_RoleBasedAuthorizationService class 224. Second, the SupportedMethods property of an instance of the CIM_EnabledLogicalElementCapabilities 306 may be utilized to determine availability of the requested operation via an associated instance of the CIM_Role class 304 corresponding to the specific role. Consequently, only after successful validation of the availability of the requested operation in both levels, an operational method may be invoked via an instance of the CIM_RoleBasedAuthorizationService class 208. Therefore, only a single instance of the CIM_RoleBasedAuthorizationService class 224 may be necessary in the network device 104.

Similarly, the CIM_EnabledLogicalElementCapabilities 306 may enable instance-specific authorization of requested account based service requests. An instance of the CIM_EnabledLogicalElementCapabilities 306 may be instantiated in lieu of the CIM_EnabledLogicalElementCapabilities 228 in the SIM profile, as substantially described in FIG. 2B. During account based authorization, a two-level validation may be utilized in the network device 104. First, service-level authorization may be performed, wherein the SupportedMethods property of an instance of the CIM_AccountManagementCapabilities class 226 may be utilized to determine availability of the requested operation via an associated instance of the CIM_AccountManagementService class 224. Second, the SupportedMethods property of an instance of the CIM_EnabledLogicalElementCapabilities 306 may be utilized to determine availability of the requested operation via an associated instance of the CIM_Account class 222 corresponding to the specific account. Consequently, only after successful validation of the availability of the requested operation in both levels, an operational method may be invoked via an instance of the CIM_AccountManagementService class 224. Therefore, only a single instance of the CIM_AccountManagementService class 224 may be necessary in the network device 104.

Additionally, instances of CIM_Role 304 and/or CIM_Account 222 classes may also advertise instance-specific service operations via associated instances of the CIM_EnabledLogicalElementCapabilities class 306. For example, an instance of the CIM_Role 304 may be enabled to advertise, via the management connection 106 for example, available role based services operations through the role instance, wherein availability of service operations in the role instance may be determined based on the SupportedMethods property of an associated CIM_EnabledLogicalElementCapabilities class 306. Similarly, an instance of the CIM_Account 306 may be enabled to advertise, via the management connection 106 for example, available account based services operations through the account instance, wherein availability of service operations in the account instance may be determined based on the SupportedMethods property of an associated CIM_Enabled LogicalElementCapabilities class 306.

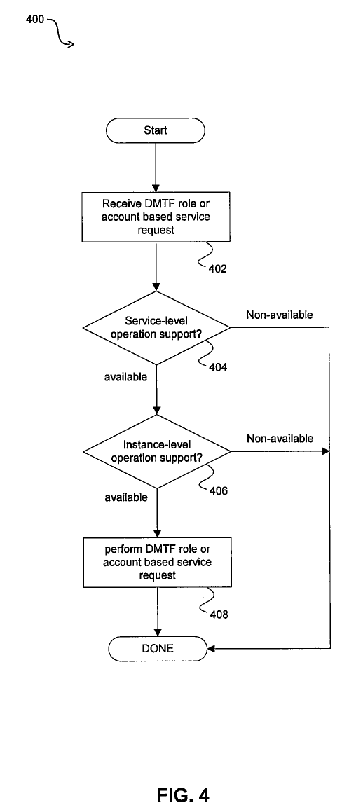

FIG. 4 is a flow chart that illustrates two-level authorization of role and/or account based services in a network device, in accordance with an embodiment of the invention. Referring to FIG. 4, there is shown a flow chart 400 comprising a plurality of exemplary steps, which may enable two-level authorization of role and/or account based service requests in a managed system, for example the network device 104.

In step 402, an account and/or role based service operation request may be received in a managed system. For example, a request for ‘CreateRole’ or account ‘Modify’ may be sent to the network device 104, via the management device 102 and the management connection 106. In step 404, a determination of the service-level availability of requested operation may be performed. For example, with role based operations, role authorization may comprise determining supported of necessary operational methods via the CIM_RoleBasedAuthorizationService class 206 and an associated CIM_RoleBasedManagementCapabilities class 208. Similarly, with account based operations, account authorization may comprise determining support of necessary operational methods via the CIM_AccountManagementService class 224 and an associated CIM_AccountManagementCapabilities class 226. In instances where it may be determined that service-level support is non-available, the exemplary steps may terminate.

Returning to step 404, in instances where it may be determined that service-level support is available, the exemplary steps may proceed to step 406. In step 406, a determination of the instance-level availability of requested operation may be performed. For example, with role based operations, role authorization may comprise determining support for necessary operational methods via a specific instance of the CIM_Role class 304 based on determination of appropriate values of the SupportedMethods property of an associated CIM_EnabledLogicalElementCapabilities class 306. Similarly, with account based operations, account authorization may comprise determining support for necessary operational methods via a specific instance of the CIM_Account class 222 based on determination of appropriate values of the SupportedMethods property of an associated CIM_EnabledLogicalElementCapabilities class 306. In instances where it may be determined that instance-level support is non-available, the exemplary steps may terminate.

Returning to step 406, in instances where it may be determined that instance-level support may be available, the exemplary steps may proceed to step 408. In step 408, the requested operational service may be performed in the network device 104. For example, with role based operations, an operational method, corresponding to the requested role service may be invoked via CIM_RoleBasedAuthorizationService class 206. Similarly, with account based operations, an operational method, corresponding to the requested account service may be invoked via the CIM_AccountManagementService class 224.

Various embodiments of the invention may comprise a method and system for simplifying role based authorization profile implementation. A two-level authorization of role and/or account based requested service operation may be performed in the network device 104. The network device 104 may be managed by the management device 102 and the management connection 106 via Distributed Management Task Force (DMTF) management profiles, based on the Common Information Model (CIM) protocol. The first level of authorization may be based on service-level availability of requested service operation based on determination of all available service operations in the network device 104. Within the DMTF Role Based Authorization (RBA) profile, a single instance of the CIM_RoleBasedAuthorizationService class 206 and/or single instance of the CIM_RoleBasedManagementCapabilities class 208 may enable performing service-level authorization. Similarly, within the DMTF Simple Identity Management (SIM) profile, a single instance of the CIM_AccountManagementService class 224 and/or single instance of the CIM_AccountManagementCapabilities class 226 may enable performing service-level authorization. A second level authorization may be based on instance-level availability of requested service operation based on determination of available service operations via a specific role and/or account instance. Within the RBA profile, a single instance of the CIM_EnabledLogicalElementCapabilities class 306 associated with a single instance of the CIM_Role class 304 may enable performing instance-level authorization. Similarly, within the SIM profile, a single instance of the CIM_EnabledLogicalElementCapabilities class 306 associated with a single instance of the CIM_Account class 222 may enable performing instance-level authorization. Instances of CIM_Role 304 and/or CIM_Account 222 classes may also advertise instance-specific service operations via associated instances of the CIM_EnabledLogicalElementCapabilities class 306.

Another embodiment of the invention may provide a machine-readable storage, having stored thereon, a computer program having at least one code section executable by a machine, thereby causing the machine to perform the steps as described herein for simplifying role based authorization profile implementation.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for network management, the method comprising: validating requested role and/or account based management services in a network device utilizing two-level authorization.

2. The method according to claim 1, wherein said two-level authorization is based on Common Information Model (CIM) data model.

3. The method according to claim 2, comprising verifying, at a first level of said two-level role authorization, availability of a requested service based on determination of available services for available roles in said network devices.

4. The method according to claim 3, comprising determining at said first level of said two-level role authorization, said service availability utilizing a single instance of CIM_RoleBasedManagementCapabilities class.

5. The method according to claim 3, comprising determining, at a second level of said two-level role authorization, available services for each of available roles in said network device utilizing a role-specific verification.

6. The method according to claim 5, comprising utilizing at said second level of said two-level role authorization, a SupportedMethods property in a single instance of CIM_EnabledLogicalElementsCapabilities class that is associated with an instance of CIM_Role class.

7. The method according to claim 2, comprising verifying at a first level of said two-level account authorization, availability of a requested service based on determination of available services for available accounts in said network devices.

8. The method according to claim 7, comprising determining at said first level of said two-level account authorization, said service availability utilizing a single instance of CIM_AccountManagementCapabilities class.

9. The method according to claim 7, determining a second level of said two-level account authorization, available services for each available accounts in said network device utilizing an account-specific verification.

10. The method according to claim 9, comprising utilizing at said second level of said two-level account authorization, a SupportedMethods property in a single instance of CIM_EnabledLogicalElementsCapabilities class that is associated with an instance of CIM_Account class.

11. The method according to claim 6, comprising advertising role capabilities of said instance of CIM_Role class based on said SupportedMethods property in said instance of CIM_EnabledLogicalElementsCapabilities class.

12. The method according to claim 10, comprising advertising account capabilities of said instance of CIM_Account class based on said SupportedMethods property in said instance of CIM_EnabledLogicalElementsCapabilities class.

13. A system for network management, the system comprising: one or more processors that enable validation of requested Distributed Management Task Force (DMTF) role and/or account based management services in a network device utilizing two-level authorization.

14. The system according to claim 13, wherein said two-level authorization is based on Common Information Model (CIM) data model.

15. The system according to claim 14, wherein said one or more processors enable, at a first level of said two-level role authorization, verification of availability of a requested service based on determination of available services for available roles in said network devices.

16. The system according to claim 15, wherein said one or more processors enable determination, at said first level of said two-level role authorization, of said service availability utilizing a single instance of CIM_RoleBasedManagementCapabilities class.

17. The system according to claim 15, wherein said one or more processors enable determination, at a second level of said two-level role authorization, of available services for each of available roles in said network device utilizing a role-specific verification.

18. The system according to claim 17, wherein said one or more processors enable utilization, at said second level of said two-level role authorization, of a SupportedMethods property in a single instance of CIM_EnabledLogicalElementsCapabilities class that is associated with an instance of CIM_Account class.

19. The system according to claim 14, wherein said one or more processors enable, at a first level of said two-level account authorization, verification of availability of a requested service based on determination of available services for available accounts in said network devices.

20. The system according to claim 19, wherein said one or more processors enable determination, at said first level of said two-level account authorization, of said service availability utilizing a single instance of CIM_AccountManagementCapabilities class.

21. The system according to claim 19, wherein said one or more processors enable determination, at a second level of said two-level account authorization, of available services for each of available accounts in said network device utilizing an account-specific verification.

22. The system according to claim 21, wherein said one or more processors enable utilization, at said second level of said two-level account authorization, of a SupportedMethods property in a single instance of CIM_EnabledLogicalElementsCapabilities class that is associated with an instance of CIM_Account class.

23. The method according to claim 18, wherein said one or more processors enable advertisement of role capabilities of said instance of CIM_Role class based on said SupportedMethods property in said instance of CIM_EnabledLogicalElementsCapabilities class.

24. The method according to claim 22, wherein said one or more processors enable advertisement of account capabilities of said instance of CIM_Account class based on said SupportedMethods property in said instance of CIM_EnabledLogicalElementsCapabilities class.
